(19) United States
(12) Patent Application Publication
(10) Pub. No.: US 2020/0154439 A1
(43) Pub. Date: May 14, 2020

(54) METHOD AND APPARATUS FOR PERSISTENT SCHEDULING ADAPTATION

(71) Applicant: Nokia Technologies Oy, Espoo (FI)

(72) Inventor: Kari Juhani NIEMELA, Oulu (FI)

(21) Appl. No.: 16/619,233

(22) PCT Filed: Jun. 14, 2018
(86) PCT No.: PCT/IB2018/054389

§ 371 Date: Dec. 4, 2019

Related U.S. Application Data
(60) Provisional application No. 62/520,997, filed on Jun. 16, 2017.

(51) Int. Cl. H04W 72/04; H04W 72/12

(52) U.S. Cl. CPC H04W 72/0493; H04W 72/0446; H04W 72/1257; H04W 72/042

(57) ABSTRACT

In accordance with an example embodiment of the present invention, an apparatus transmit a persistent resource allocation in accordance with a periodicity to a user equipment, determines at least one resource-shift of a resource of the persistent resource allocation, transmits an indication of the at least one resource-shift to the user equipment; and transmits or receives data to or from the user equipment in accordance with the resource-shifted persistent resource allocation. In another example embodiment of the present invention, an apparatus receives a persistent resource allocation in accordance with a periodicity from a network node, receives an indication of at least one resource-shift of a resource of the persistent resource allocation, adapts at least one resource of the persistent resource allocation in accordance with the at least resource-shift, and transmits or receives data to or from a network node in accordance with the adapted persistent resource allocation.

### CROSS-REFERENCE TO RELATED APPLICATIONS

This application claims priority from U.S. Provisional Application No. 62/5209,97, filed on Jun. 16, 2017.

### TECHNICAL FIELD

The present application relates generally to efficient adaptation of (semi) persistent scheduling in radio networks.

### BACKGROUND

Many services for which data is to be transferred over radio networks generate data in a periodic fashion. For example voice services generate packets at intervals of typically 20 milliseconds. To facilitate the transfer of this data without having to schedule a radio resource allocation for each individual packet, radio schedulers typically facilitate persistent or semi-persistent allocations, which provide a plurality of periodically occurring resources, wherein the difference between persistent and semi-persistent allocations generally exist in that persistent allocations provide unlimited periodically occurring resources until the persistent allocation is explicitly or implicitly canceled and semi-persistent allocations provide a limited number of of periodically occurring resources, e.g., upon voice activity. The invention as disclosed in the present application may be be equally applied to persistent and semi-persistent scheduling, which for brevity of notation will infra collectively be referred to as persistent scheduling or persistent allocation.

Updating of an active persistent allocation is generally performed only by full replacement of the persistent allocation, often requiring first terminating the active allocation.

### SUMMARY

Various aspects of examples of the invention are set out in the claims.

According to a first aspect of the present invention, there is disclosed an apparatus, computer program product and method for transmitting a persistent resource allocation in accordance with a periodicity to a user equipment; determining at least one resource-shift of a resource of the persistent resource allocation; transmitting an indication of the at least one resource-shift to the user equipment; and transmitting or receiving data to or from the user equipment in accordance with the resource-shifted persistent resource allocation.

According to a second aspect of the present invention, there is disclosed an apparatus, computer program product and method for receiving a persistent resource allocation in accordance with a periodicity from a network node; receiving an indication of at least one resource-shift of a resource of the persistent resource allocation; adapting at least one resource of the persistent resource allocation in accordance with the at least resource-shift; and transmitting or receiving data to or from a network node in accordance with the adapted persistent resource allocation.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an embodiment of a persistent allocation in accordance with the present invention;

FIG. 2 illustrates another embodiment of a persistent allocation in accordance with the present invention; and

FIG. 3 illustrates a plurality of resource-shift signaling options; and

FIG. 4 illustrates a signaling in accordance with embodiments of the invention; and

FIG. 5 illustrates flow diagrams in accordance with embodiments of the invention; and

FIG. 6 illustrates a block diagram illustrating an example wireless apparatus in accordance with embodiments of the invention.

### DETAILED DESCRIPTION

Many services for which data is to be transferred over radio networks generate data in a periodic fashion. In general, and particularly for latency critical and ultra-reliable services, it is desirable not to restrict the feasible periodicity in accordance with the numerology of any radio interface over which the service is to be carried. Therefore, it may be desirable to support any arbitrary periodicity irrespective of a unit of resource allocation available on the radio interface. In addition, it is desirable to minimize the control signaling overhead on the radio interface to support such an arbitrary periodicy, such that it is preferable to avoid having to signal a new persistent resource allocation. Embodiments of the present invention as disclosed herein provide for the support by a radio interface of any periodicity with very limited control signal overhead.

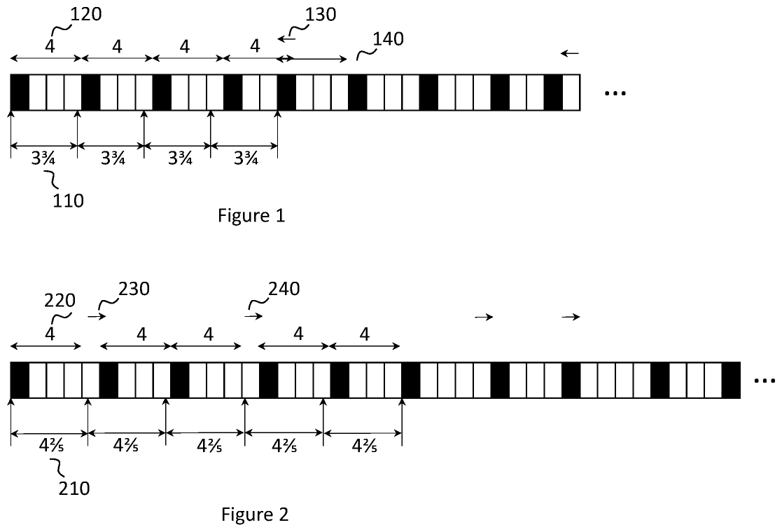

FIG. 1 illustrates an embodiment of a persistent allocation in accordance with the present invention. At 110, it is depicted a service requiring a periodicity that equates to 3¾ of a radio resource time unit. Such may for example occur if the radio resource time unit is 4 ms and the desired periodicity is 15 ms. At 120, it is depicted that a persistent resource allocation is configured with a periodicity of 4 radio resource time units, for example 16 ms. The configured periodicity may for example be derived from the desired periodicity be means of a rounding or ceiling function, where the value applied to the function may be the desired periodicity expressed in radio resource time units. At 130, it is depicted that a resource-shift is introduced, which advances the persistent resource allocation with one resource unit. That is, instead of the periodic interval of 4 radio resource units, the instant radio resource is allocated after 3 radio resource units. From this advanced instant resource, subsequent radio resources, starting with 140, are again provisioned with the periodicity of 4 radio resource time units relative to the advanced radio resource, such that the resource-shift has the effect of persistently advancing all subsequent radio resources of the persistent allocation by the one unit resource-shift. The resource-shift causes the radio resources of the persistent allocation to no longer be equi-distant, but achieves the desired effect of facilitating the desired periodicity of 3¾ radio resource time units using radio resources generally configured in accordance with the expected arrival time in accordance with the desired periodicity. In general, where the desired periodicity is not an integer multiple of the radio resource time unit, the desired periodicity will infra be referred to as a fractional periodicity.

A resource-shift within the context of the present disclosure is hence a transferring of an allocation from one radio resource unit to another, typically but not necessarily time-adjacent, radio resource unit without changing of the time-reference of the frame structure in which the radio resource units are transmitted. This in contrast to merely shifting the time-reference of a transmitting signal, such as for example wellknown from source clock drift adjustments or adjustment of a timing advance to accommodate propagation delay.

The radio resource time unit may be one of a symbol, mini-slot, slot, subframe, frame, superframe or any other unit used by the air interface. It may be understood that the radio resource time unit is not necessarily the smallest granularity resource within the air interface, but can for example also be a resource unit in which the persistent scheduling is provided. For example, the persistent scheduling may be provided in units of subframes, wherein a subframe is further divisible in slots.

FIG. 2 illustrates another embodiment of a persistent allocation in accordance with the present invention. At 210, it is depicted a service requiring a periodicity that equates to 4⅖ of a radio resource time unit. Such may for example occur if the radio resource time unit is 5 ms and the desired periodicity is 22 ms. At 220, it is depicted that a persistent resource allocation is configured with a periodicity of 4 radio resource time units, for example 20 ms. The configured periodicity may for example be derived from the desired periodicity be means of a rounding or ceiling function, where the value applied to the function may be the desired periodicity expressed in radio resource time units. At 230 and 240, it is depicted that a resource-shift is introduced, which delays the persistent resource allocation with one resource unit. That is, instead of the periodic interval of 4 radio resource units, the instant radio resource is allocated after 5 radio resource units. From these delayed instant resource, subsequent radio resources are again provisioned with the periodicity of 4 radio resource time units relative to the delayed radio resource, such that the resource-shift has the effect of persistently delaying all subsequent radio resources of the persistent allocation by the one unit resource-shift. Also in this embodiment, the resource-shift causes the radio resources of the persistent allocation to no longer be equi-distant in radio interface, but achieves the desired effect of facilitating the desired periodicity of 4⅖ radio resource time units using radio resources generally configured in accordance with the expected arrival time in accordance with the desired periodicity.

One skilled in the art will appreciate that the resource-shifts may be applied periodically. For examine, in the example depicted in FIG. 1, the advance may be applied to every fourth periodic resource, after the first resource, whereas in the example depicted in FIG. 2, the delay may be applied to every second and fourth periodic resource out of every five resources after the first resource of the persistent allocation.

In one embodiment, a resource-shift may be provided for a persistent allocation in accordance with an equation:

$$\{ \begin{matrix}⌈ n \cdot {P}_{fractional} ⌉ < ⌈ ( n - 1 ) \cdot {P}_{fractional} ⌉ + {P}_{configured} & advance \\ ⌈ n \cdot {P}_{fractional} ⌉ > ⌈ ( n - 1 ) \cdot {P}_{fractional} ⌉ + {P}_{configured} & delay \\ ⌈ n \cdot {P}_{fractional} ⌉ = ⌈ ( n - 1 ) \cdot {P}_{fractional} ⌉ + {P}_{configured} & no resource \text{-} shift\end{matrix}$$

wherein P_{fractional} denotes the desired fractional periodicity and P_{configured} denotes the configured periodicity, where n∈ [symbol] ⁺ denotes the n^{th} resource after the first resource configured by the persistent allocation.

In another embodiment, one or more delays may be provided for the resources immediately following the first resource. For example, in relation to FIG. 2, rather than delaying each second and fourth resource out of every five resources, the second and third resource may be delayed. It is naturally also possible to delay another pair than then second and fourth or second and third resource, but this is generally not preferred as it necessitates a general additional delay of the entire periodic allocation to avoid allocations occurring before packets have arrived in accordance with their expected arrival time. Similarly, it may be desirable to allocate advances no earlier than provided by the above equation.

In yet another embodiment, it may be desired to provide non-persistent advances or delays to the configured persistent allocation. That is, unlike in the case of persistent advances or delays, only the resource indicated to be resource-shifted is resource-shifted without impact on any subsequent resource of the persistent allocation. Naturally it is also possible to provide persistent and non-persistent resource-shifts in combination.

In a further embodiment, it may be desirable to provide persistent resource advance or resource delay in accordance with a drifted packet arrival time. While a persistent allocation may have been configured in accordance with configured periodicity that matches a periodic packet arrival time of a service at the transmitter or may be configured with a configured periodicity that is matched to a desired fractional periodicity through resource advances and/or delays, a drift may occur between the matched periodicity and the periodic packet arrival time at the transmitter. This may for example occur if the clock running the service generating the packets to be transmitted is not matched to the clock of the radio interface, which in essence causes the packets to arrive at the radio transmitter with a fractional persistency. For a persistent uplink allocation, a user equipment may inform a base station of a need to insert a resource advance or resource delay for this purpose. This may be triggered at the UE by a determination that the time interval between the packet arrival time at the UE's radio interface and the corresponding persistent resource becomes too large (meriting a resource advance) and/or too small (meriting a resource delay). A similar trigger based determination may be made by a base station for a downlink persistent allocation.

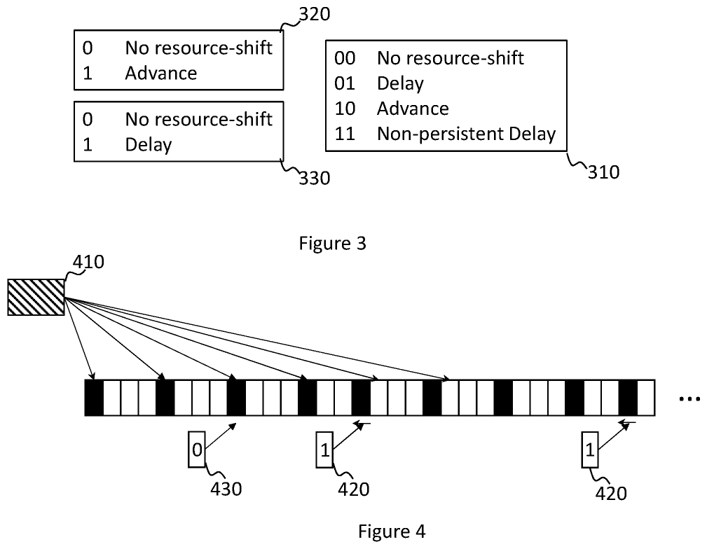

To facilitate signaling of a persistent allocation, signaling may be performed in accordance with known art. For example, a persistent allocation may be configured and activated in accordance with the 3GPP LTE standard. In accordance with embodiments of the invention as depicted in FIG. 3, it may be signaled as depicted in 310 for a resource configured by the persistent allocation whether the resource should be delayed, advanced or whether no resource-shift is to be performed. A fourth value of the signal may remain unused, used for purposes outside the scope of the present invention or may be used to indicate a non-persistent delay of the resource. One skilled in the art will naturally appreciate that more bits may be used for the signaling or that the depicted bit values are associated differently without departing from the scope of the invention. For example, an amount of the resource-shift may be explicitly provided.

In accordance with other embodiments of the inventions, a resource-shift may be indicated with a one bit indication, where one value of the bit indicates no resource-shift is to be performed and the other value indicates as depicted at 320 that an advance is to be performed, whereas, as depicted at 330, the other value indicates that a delay is to be performed. Whether to associate the other value with advance or delay may for example be signaled with the configuration of the persistent allocation. Signaling in accordance with embodiments 310, 320 and 330 may for example be performed in a medium access control information element (MAC IE) or by a physical layer signaling or in radio resource control (RRC) signaling.

In an alternative embodiment, the resources to periodically delay or advance may be indicated with the configuration of the persistent allocation, such that no individual signaling per persistent resource is required. For example, in accordance with the example as depicted in FIG. 1, a bitmap sequence [001] may be signaled indicating that the second and third resource out of every fourth are not to be resource-shifted while the fourth resource out of every fourth resource is to be resource-shifted. Since the first resource may not be shifted by default, no bit indication is necessary for this resource. In accordance with the example as depicted in FIG. 2, a bitmap sequence [1010] may be signaled indicating that the third and fifth out of every five resources of the persistent allocation are not to be shifted, whereas the second and fourth are to be resource-shifted. Whether the resource-shift is to be an advance or a delay may be signaled with a separate value, or may be implicitly derived from the locations of the resource-shifts in the bitmap.

In yet another alternative embodiment, the desired fractional periodicity may be signaled with the configuration of the persistent allocation. A user equipment may then derive the occurrences of resource-shifts from the configured periodicity and the desired fractional periodicity from a rule mutually understood by a network node providing the persistent allocation and a user equipment receiving the persistent allocation. Such a rule may for example be the equation provided supra. In such cases, the network node may not explicitly signal the configured periodicity, but signal the configured periodicity implicitly through the desired fractional periodicity, wherein a user equipment may derive the configured periodicity from the signaled desired fractional periodicity, for example by one of a rounding, ceiling or floor function.

In certain embodiments, a user equipment might request a base station to provision a persistent allocation to the user equipment in accordance with a desired fractional periodicity. In such a case, it is for example possible that the base station and user equipment are configured to commonly interpret an allocation of a persistent allocation with a configured periodicity to implicitly signal that the desired fractional periodicity is provided, for example when the configured periodicity corresponds to the requested desired fractional periodicity according to a rule such, where a rule may be provided by one of a rounding, ceiling or floor function. In such an embodiment, the indication of the resource shift may thus signaled through the configured periodicity.

FIG. 4 provides an illustration of signaling in accordance with embodiments of the invention. At 410, the the persistent resource allocation configuration is signaled, providing for periodically allocated resources. In addition, activation of the persistent resource allocation may be need to be signaled, for example in accordance with the 3GPP LTE standard. At 420, it is signaled that a resource of the persistent resource allocation is to be shifted, the signaling for example as depicted in FIG. 3 at 320. This signaling may be provided in a MAC IE. In some embodiments, the signal indicating whether a resource-shift is required may only be provided when a resource-shift is required. In other embodiments, the signal may also be provided when no resource-shift is required, such as depicted at 430.

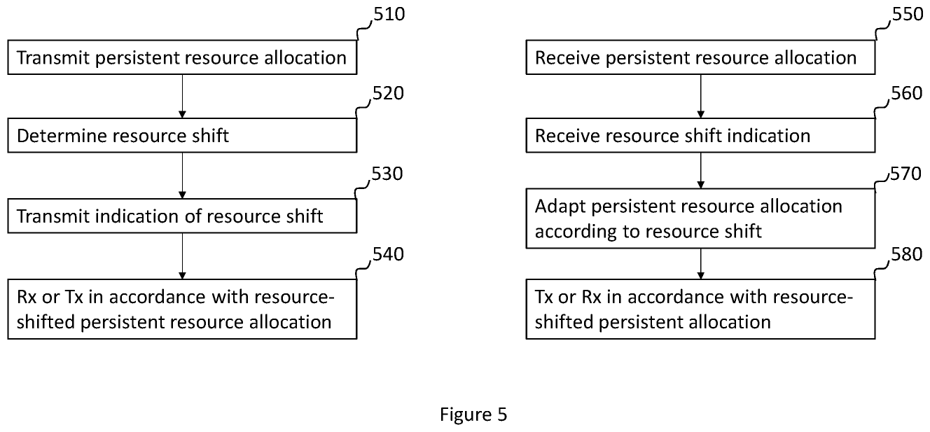

FIG. 5 depicts flows diagrams accordance to embodiments of the invention. At 510, a persistent resource allocation is transmitted, generally indicating a configured periodicity of allocated resources. The configured periodicity may for example be derived from a desired fractional periodicity as disclosed supra. At 520, a resource shift for a resource of the persistent allocation is determined, which at 530 is transmitted. The order of 510, 520 and 530 is not limited to the one depicted. For example, if the resource shift is signaled in accordance with embodiments depicted in FIG. 3 at 310, 320, 330, the depicted order may occur. In another example, if the resource shift is indicated by signaling the desired fractional periodicity or signaling a bit map, such indicated may occur as part of transmitting the persistent resource allocation, such that 510 and 530 occur essentially simultaneously, where determining a resource shift 520 may occur prior to 510 and 530, for example if a bitmap of resource shifts is signaled, or may occur after 510 and 530, for example if the desired fractional periodicity is signaled. However, each of 510, 520 and 530 generally occur before transmission or reception in accordance with the resource-shifted persistent resource allocation. The process comprising 510-540 may typically be executed by a control node such as a base station, a master node, in infrastructure node or an access point or in any case a node controlling allocation of radio resources, such as for example a user equipment controlling allocation of radio resources for a smart watch.

At 550, a persistent resource allocation is received, generally comprising an indication of a configured periodicity of allocated resources. The indication may contain the configured periodicity of allocated resources or a desired fractional periodicity from the configured periodicity may be derived. At 560, a resource shift indication is received. The resource shift for example be contained in a RRC or MAC IE or physical layer signaling and may be formatted as depicted in FIG. 3 at 310, 320 or 330. In other embodiments, the source shift may be signaled in a bitmap or through an indication of the desired fractional periodicity comprised in the received persistent resource allocation. In any case, at 570 the persistent resource allocation is adapted according to the signaled resource shift. Finally at 580, transmission or reception in accordance with the resource-shifted persistent allocation is performed. The process comprising 550-580 may typically be executed by a user equipment or in any case a device accepting radio resource allocations from another node.

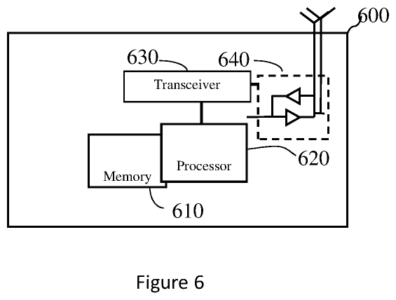

FIG. 6 depicts a block diagram illustrating an example wireless apparatus (600) in accordance with embodiments of the invention. The wireless apparatus may include at least one processor (620), at least one memory (610) coupled to the at least one processor (620) and at least one suitable transceiver (630) having a transmitter and a receiver coupled to the at least one processor (620), coupled to at least one antenna unit (650) through at least one amplifier (640).

The at least one memory (610) may store computer programs, which may, when executed by the at least one processor (620), for example in combination with any of the at least one transceiver (630), at least one amplifier (640) and at least one antenna unit (650), perform embodiments of the invention. For example an infrastructure node or user equipment may be embodied in apparatus 600.

Embodiments of the invention may be implemented in software (executed by one or more processors), hardware (e.g., an application specific integrated circuit or field programmable gate array), or a combination of software and hardware. In an example embodiment, the software (e.g., application logic, an instruction set) is maintained on any one of various conventional non-transitory computer-readable media.

Although various aspects are set out above, other aspects comprise other combinations of features from the described embodiments, and not solely the combinations described above.

1-42. (canceled)

43. An apparatus, comprising:
at least one processor; and
at least one memory including computer program code;
the at least one memory and the computer program code configured to, with the at least one processor, cause the apparatus to:
transmit a persistent resource allocation in accordance with a periodicity to a user equipment;
determine at least one resource-shift of a resource of the persistent resource allocation in accordance with a fractional periodicity;
transmit an indication of the at least one resource-shift to the user equipment; and
transmit or receive data to or from the user equipment in accordance with the resource-shifted persistent resource allocation.

44. The apparatus of claim 43, wherein the at least one resource-shift adapts the persistent resource allocation to substantially match the fractional periodicity.

45. The apparatus of claim 43, wherein the periodicity relates to the fractional periodicity through at least one of a floor, ceiling or rounding function.

46. The apparatus of claim 43, wherein the indication of the at least one resource-shift comprises an indication of the fractional periodicity.

47. The apparatus of claim 43, wherein each of the at least one resource-shift is one of a resource advance or a resource delay.

48. The apparatus of claim 43, wherein determination of the at least one resource-shift comprises:
determine the at least one resource-shift in accordance with a received request to provision the persistent allocation with the fractional periodicity.

49. The apparatus of claim 43, wherein whether each of the at least one resource-shift is a resource advance or a resource delay is received with the persistent allocation.

50. The apparatus of claim 43, wherein the indication of the at least one resource-shift comprises an indication of a periodic shift.

51. The apparatus of claim 43, wherein the indication of the at least one resource-shift comprises an indication of the fractional periodicity.

52. An apparatus, comprising:
at least one processor; and
at least one memory including computer program code;
the at least one memory and the computer program code configured to, with the at least one processor, cause the apparatus to:
receive a persistent resource allocation in accordance with a periodicity from a network node;
receive an indication of at least one resource-shift of a resource of the persistent resource allocation in accordance with a fractional periodicity;
adapt at least one resource of the persistent resource allocation in accordance with the at least resource-shift; and
transmit or receive data to or from the network node in accordance with the adapted persistent resource allocation.

53. The apparatus of claim 52, wherein the at least one resource-shift is one of a resource advance or a resource delay.

54. The apparatus of claim 52, wherein whether each of the at least one resource-shift is a resource advance or a resource delay is received with the persistent allocation.

55. The apparatus of claim 52, wherein the indication of the at least one resource-shift comprises an indication of a periodic shift.

56. The apparatus of claim 52, wherein the persistent allocation is received in response to a request transmitted by the apparatus to provide the persistent allocation in accordance with the fractional periodicity.

57. The apparatus of claim 52, wherein the at least one resource-shift adapts the persistent resource allocation to substantially match the fractional periodicity.

58. The apparatus of claim 52, wherein the persistent allocation is received in response to a request transmitted by the apparatus to provide the persistent allocation in accordance with the fractional periodicity.

59. The apparatus of claim 52, wherein the periodicity relates to the fractional periodicity through at least one of a floor, ceiling or rounding function.

60. A method comprising:
receiving a persistent resource allocation in accordance with a periodicity from a network node;
receiving an indication of at least one resource-shift of a resource of the persistent resource allocation in accordance with a fractional periodicity;
adapting at least one resource of the persistent resource allocation in accordance with the at least resource-shift; and
transmitting or receiving data to or from the network node in accordance with the adapted persistent resource allocation.

61. The method of claim 60, wherein the persistent allocation is received in response to a transmitted request to provide the persistent allocation in accordance with the fractional periodicity.

62. The method of claim 60, wherein the periodicity relates to the fractional periodicity through at least one of a floor, ceiling or rounding function.
